(19) United States
(12) Patent Application Publication
(10) Pub. No.: US 2025/0374140 A1
(43) Pub. Date: Dec. 4, 2025

(54) COMMUNICATION CONTROL METHOD, USER EQUIPMENT, CELLULAR COMMUNICATION SYSTEM, PROGRAM, AND CHIPSET

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 19/297,856

(22) Filed: Aug. 12, 2025

Related U.S. Application Data
(63) Continuation of application No. PCT/JP2024/004599, filed on Feb. 9, 2024.

(30) Foreign Application Priority Data
Feb. 13, 2023 (JP) 2023-019955

(51) Int. Cl. H04W 36/08; H04W 48/08; H04W 88/08

(52) U.S. Cl. CPC H04W 36/08; H04W 48/08; H04W 88/08

(57) ABSTRACT

In an aspect, a communication control method is used in a cellular communication system. The communication control method includes a step of receiving, by a user equipment, mobile-IAB cell type information indicating being a mobile IAB cell from the mobile IAB cell. The communication control method includes a step of performing, by the user equipment, either one of executing an inter-frequency cell reselection procedure by considering a frequency priority of a frequency used in the mobile IAB cell as the highest priority, or executing the inter-frequency cell reselection procedure by considering the frequency priority of the frequency used in the mobile IAB cell as the lowest priority.

### RELATED APPLICATIONS

The present application is a continuation based on PCT Application No. PCT/JP2024/004599, filed on Feb. 9, 2024, which claims the benefit of Japanese Patent Application No. 2023-019955 filed on Feb. 13, 2023. The content of which is incorporated by reference herein in their entirety.

### TECHNICAL FIELD

The present disclosure relates to a communication control method used in a cellular communication system, a user equipment, a cellular communication system, a program, and a chipset.

### BACKGROUND

The Third Generation Partnership Project (3GPP) (trade name; the same applies below), a standardization project for cellular communication systems, is studying the introduction of a new relay node referred to as an Integrated Access and Backhaul (IAB) node (see Non-Patent Document 1, for example). One or more relay nodes are involved in communication between a base station and a user equipment and perform relay for the communication.

### CITATION LIST

### Non-Patent Literature

Non-Patent Document 1: 3GPP TS 38.300 V17.3.0 (2022-12)

### SUMMARY

In a first aspect, a communication control method is used in a cellular communication system. The communication control method includes a step of receiving, by a user equipment, mobile-IAB cell type information indicating being a mobile IAB cell from the mobile IAB cell. The communication control method includes a step of executing, by the user equipment, an inter-frequency cell reselection procedure by considering a frequency priority of a frequency used by a mobile IAB cell as the highest priority.

In a second aspect, a communication control method is a communication control method to be used in a cellular communication system. The communication control method includes a step of receiving, by a user equipment, connection grant information indicating presence or absence of connection grant to a mobile IAB cell from a network. The communication control method includes a step of receiving, by the user equipment, mobile-IAB cell type information indicating being a mobile IAB cell from the mobile IAB cell. The communication control method includes a step of performing, by the user equipment, either one of executing predetermined processing on a mobile IAB cell based on connection grant information, or not executing the predetermined processing on the mobile IAB cell. The predetermined processing is at least any of considering that the mobile IAB cell is not barred, camping on the mobile IAB cell, and establishing an RRC connection to the mobile IAB cell.

In a third aspect, a user equipment is used in a cellular communication system. The user equipment includes a receiver configured to receive mobile-Integrated Access and Backhaul (IAB) cell type information indicating being a mobile IAB cell from the mobile IAB cell, and a controller configured to execute an inter-frequency cell reselection procedure by considering a frequency priority of a frequency used in the mobile IAB cell as the highest priority.

In a fourth aspect, a cellular communication system includes a mobile Integrated Access and Backhaul (IAB) cell and a user equipment, in which the user equipment receives mobile-IAB cell type information indicating being a mobile Integrated Access and Backhaul (IAB) cell from the mobile IAB cell, and the user equipment executes an inter-frequency cell reselection procedure by considering a frequency priority of a frequency used in the mobile IAB cell as the highest priority.

In a fifth aspect, a program causes a computer of a user equipment in a cellular communication system to execute: processing of receiving mobile-Integrated Access and Backhaul (IAB) cell type information indicating being a mobile IAB cell from the mobile IAB cell; and processing of executing an inter-frequency cell reselection procedure by considering a frequency priority of a frequency used in the mobile IAB cell as the highest priority.

In a sixth aspect, a chipset is used in a user equipment in a cellular communication system. The chipset executes processing of receiving mobile-Integrated Access and Backhaul (IAB) cell type information indicating being a mobile IAB cell from the mobile IAB cell, and processing of executing an inter-frequency cell reselection procedure by considering a frequency priority of a frequency used in the mobile IAB cell as the highest priority.

### BRIEF DESCRIPTION OF THE DRAWINGS

FIG. 1 is a diagram illustrating a configuration example of a cellular communication system according to an embodiment.

FIG. 2 is a diagram illustrating a relationship between an IAB node, Parent nodes, and Child nodes.

FIG. 3 is a diagram illustrating a configuration example of a gNB (base station) according to the embodiment.

FIG. 4 is a diagram illustrating a configuration example of an IAB node (relay node) according to the embodiment.

FIG. 5 is a diagram illustrating a configuration example of a UE (user equipment) according to the embodiment.

FIG. 6 is a diagram illustrating an example of a protocol stack related to an RRC connection and a NAS connection of an IAB-MT.

FIG. 7 is a diagram illustrating an example of a protocol stack related to an F1-U protocol.

FIG. 8 is a diagram illustrating an example of a protocol stack related to an F1-C protocol.

FIG. 9 is a diagram illustrating an operation example according to a first embodiment.

FIG. 10 is a diagram illustrating an operation example according to a second embodiment.

### DESCRIPTION OF EMBODIMENTS

The present disclosure provides a communication control method in which a user equipment having received mobile-IAB cell type information can appropriately perform processing.

A cellular communication system according to an embodiment will be described with reference to the drawings. In the description of the drawings, the same or similar parts are denoted by the same or similar reference signs.

### First Embodiment

### Configuration of Cellular Communication System

A configuration example of the cellular communication system according to an embodiment is described. A cellular communication system 1 according to an embodiment is a 3GPP 5G system. Specifically, a radio access scheme in the cellular communication system 1 is a New Radio (NR) being a 5G radio access scheme. Note that Long Term Evolution (LTE) may be at least partially applied to the cellular communication system 1. A future cellular communication system such as 6G may be applied to the cellular communication system 1.

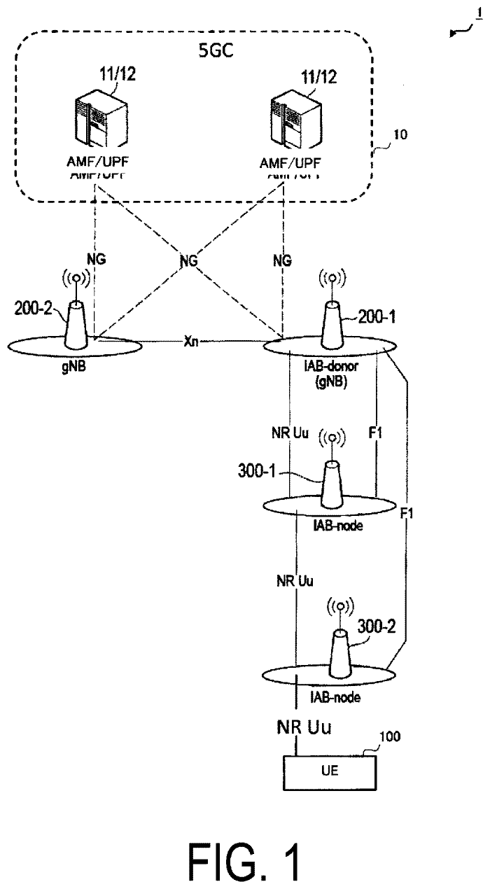

FIG. 1 is a diagram illustrating a configuration example of the cellular communication system 1 according to the embodiment.

As illustrated in FIG. 1, the cellular communication system 1 includes a 5G core network (5GC) 10, a User Equipment (UE) 100, base station apparatuses (hereinafter, may be referred to as “base stations”) 200-1 and 200-2, and IAB nodes 300-1 and 300-2. The base station 200 may be referred to as a gNB.

In the following, an example in which the base station 200 is an NR base station will be mainly described, but the base station 200 may also be an LTE base station (that is, an eNB).

In the following, the base stations 200-1 and 200-2 may be referred to as gNBs 200 (or base station 200), and the IAB nodes 300-1 and 300-2 may be referred to as IAB nodes 300.

The 5GC 10 includes an Access and Mobility Management Function (AMF) 11 and a User Plane Function (UPF) 12. The AMF 11 is an apparatus that performs various mobility controls and the like for the UE 100. The AMF 11 communicates with the UE 100 using Non-Access Stratum (NAS) signaling to manage information on an area in which the UE 100 exists. The UPF 12 is an apparatus that performs transfer control of user data, and the like.

Each gNB 200 is a fixed radio communication node and manages one or more cells. The term “cell” is used for indicating a minimum unit of a radio communication area. The term “cell” may be used for indicating a function or resource for performing radio communication with the UE 100. One cell belongs to one carrier frequency. Hereinafter, a cell and a base station may be used without distinction.

Each gNB 200 is interconnected with the 5GC 10 via an interface referred to as an NG interface. FIG. 1 illustrates two gNBs, that is, a gNB 200-1 and a gNB 200-2, connected to the 5GC 10.

Each gNB 200 may be divided into a Central Unit (CU) and a Distributed Unit (DU). The CU and the DU are interconnected via an interface referred to as an F1 interface. An F1 protocol is a communication protocol between the CU and the DU, and includes an F1-C protocol, which is a control plane protocol, and an F1-U protocol, which is a user plane protocol.

The cellular communication system 1 supports IAB, which enables radio relay of NR access using an NR for backhaul. The donor gNB 200-1 (or a donor node, which, hereinafter, may be referred to as a “donor node”) is a terminal node of the NR backhaul on a network side, and is a donor base station including additional functionality for supporting the IAB. The backhaul is capable of multi-hopping via a plurality of hops (that is, a plurality of IAB nodes 300).

FIG. 1 illustrates an example in which the IAB node 300-1 is wirelessly connected to the donor node 200-1, the IAB node 300-2 is wirelessly connected to the IAB node 300-1, and the F1 protocol is transmitted by two backhaul hops.

The UE 100 is a mobile radio communication apparatus that performs radio communication with a cell. The UE 100 may be any apparatus that performs radio communication with the gNB 200 or the IAB node 300. For example, the UE 100 is a mobile phone terminal and/or a tablet terminal, a laptop PC, a sensor or an apparatus provided in a sensor, a vehicle or an apparatus provided in a vehicle, or an aircraft or an apparatus provided in an aircraft. The UE 100 is wirelessly connected to the IAB node 300 or the gNB 200 via an access link. FIG. 1 illustrates an example in which the UE 100 is wirelessly connected to the IAB node 300-2. The UE 100 indirectly communicates with the donor node 200-1 via the IAB node 300-2 and the IAB node 300-1.

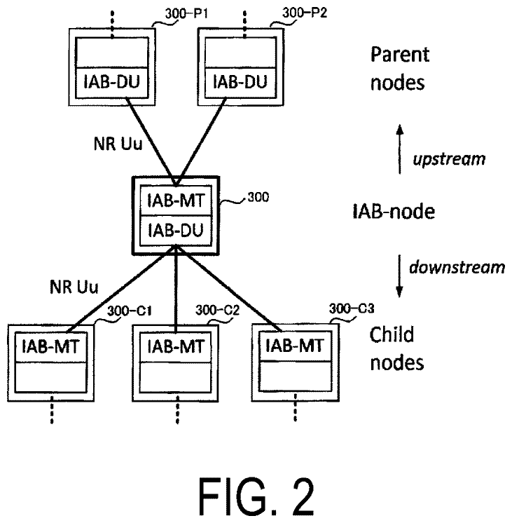

FIG. 2 is a diagram illustrating an example of a relationship between the IAB node 300, Parent nodes, and Child nodes.

As illustrated in FIG. 2, each IAB node 300 includes an IAB-DU equivalent to a base station function unit and an IAB-MT (Mobile Termination) equivalent to a user equipment function unit.

Adjacent nodes (that is, upper nodes) on an NR Uu radio interface of the IAB-MT are referred to as parent nodes. The parent node is a DU of a parent IAB node or the donor node 200. A radio link between the IAB-MT and the parent node is referred to as a backhaul link (BH link). FIG. 2 illustrates an example in which the parent nodes of the JAB node 300 are IAB nodes 300-P1 and 300-P2. A direction toward the parent nodes is referred to as upstream. From the perspective of the UE 100, the upper node of the UE 100 may correspond to a parent node.

Adjacent nodes (that is, lower nodes) on the NR access interface of the IAB-DU are referred to as child nodes. The IAB-DU manages the cell, similarly to the gNB 200. The IAB-DU terminates the NR Uu radio interface to the UE 100 and the lower JAB nodes. The IAB-DU supports the F1 protocol to the CU of the donor node 200-1. FIG. 2 illustrates an example in which the child nodes of the JAB node 300 are JAB nodes 300-C1 to 300-C3, but the child node of the IAB node 300 may also include the UE 100. A direction toward the child nodes is referred to as downstream.

All of the IAB nodes 300 connected to the donor node 200 via one or more hops form a Directed Acyclic Graph (DAG) topology (hereinafter, may be referred to as “topology”) with the donor node 200 as the root. In this topology, as illustrated in FIG. 2, adjacent nodes on the IAB-DU interface are child nodes, and adjacent nodes on the IAB-MT interface are parent nodes. The donor node 200 performs central management including resource, topology, and route management of the JAB topology. The donor node 200 is a gNB that provides network access to the UE 100 via a network of backhaul links and access links.

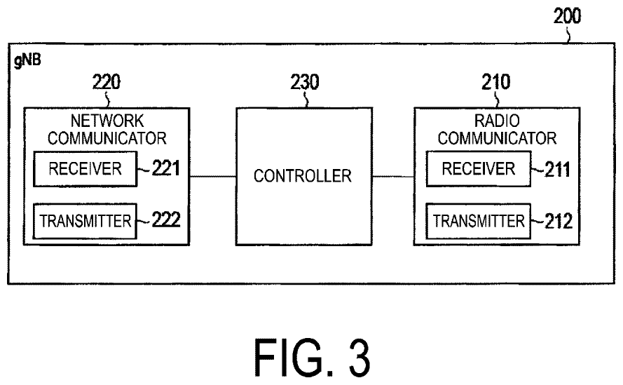

Configuration of Base Station The configuration of the gNB 200, which is a base station according to the embodiment, will be described. FIG. 3 is a diagram illustrating a configuration example of the gNB 200. As illustrated in FIG. 3, the gNB 200 includes a radio communicator 210, a network communicator 220, and a controller 230.

The radio communicator 210 performs radio communication with the UE 100 and radio communication with the JAB node 300. The radio communicator 210 includes a receiver 211 and a transmitter 212. The receiver 211 performs various types of reception under the control of the controller 230. The receiver 211 includes an antenna, and converts (down-converts) a radio signal received by the antenna into a baseband signal (reception signal) and outputs the converted signal to the controller 230. The transmitter 212 performs various types of transmission under the control of the controller 230. The transmitter 212 includes an antenna, and converts (up-converts) a baseband signal (transmission signal) output by the controller 230 into a radio signal and transmits the converted signal from the antenna.

The network communicator 220 performs wired communication (or radio communication) with the 5GC 10 and wired communication (or radio communication) with other adjacent gNBs 200. The network communicator 220 includes a receiver 221 and a transmitter 222. The receiver 221 performs various types of reception under the control of the controller 230. The receiver 221 receives a signal from the outside and outputs the reception signal to the controller 230. The transmitter 222 performs various types of transmission under the control of the controller 230. The transmitter 222 transmits a transmission signal output by the controller 230 to the outside.

The controller 230 performs various types of control for the gNB 200. The controller 230 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of layers to be described below. The controller 230 may perform each process or each operation in the gNB 200 in each embodiment to be described below.

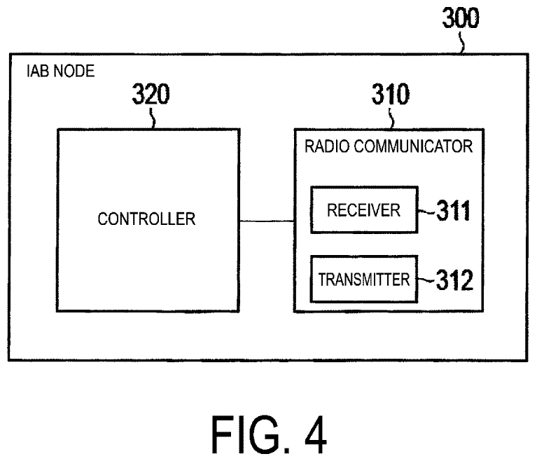

Configuration of Relay Node A configuration of the IAB node 300 that is a relay node (or a relay node apparatus, which, hereinafter, may be referred to as a “relay node”) according to the embodiment will be described. FIG. 4 is a diagram illustrating a configuration example of the IAB node 300. As illustrated in FIG. 4, the IAB node 300 includes a radio communicator 310 and a controller 320. The IAB node 300 may include a plurality of radio communicators 310.

The radio communicator 310 performs radio communication (BH link) with the gNB 200 and radio communication (access link) with the UE 100. The radio communicator 310 for BH link communication and the radio communicator 310 for access link communication may be provided separately.

The radio communicator 310 includes a receiver 311 and a transmitter 312. The receiver 311 performs various types of reception under the control of the controller 320. The receiver 311 includes an antenna, and converts (down-converts) a radio signal received by the antenna into a baseband signal (reception signal) and outputs the converted signal to the controller 320. The transmitter 312 performs various types of transmission under the control of the controller 320. The transmitter 312 includes an antenna, and converts (up-converts) a baseband signal (transmission signal) output by the controller 320 into a radio signal and transmits the converted signal from the antenna.

The controller 320 performs various types of control in the IAB node 300. The controller 320 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of layers to be described below. The controller 320 may perform each process or each operation in the IAB node 300 in each embodiment to be described below.

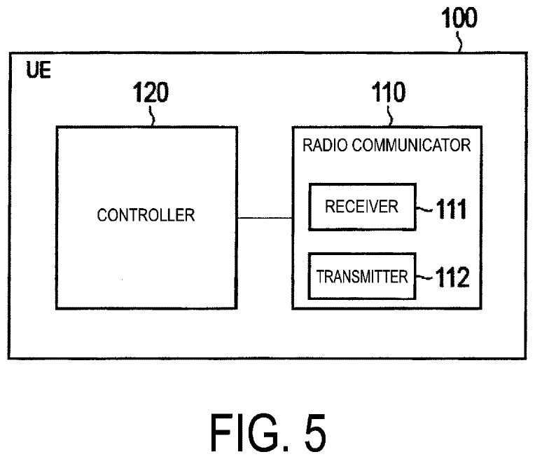

Configuration of User Equipment The configuration of the UE 100, which is a user equipment according to the embodiment, will be described. FIG. 5 is a diagram illustrating a configuration example of the UE 100. As illustrated in FIG. 5, the UE 100 includes a radio communicator 110 and a controller 120.

The radio communicator 110 performs radio communication in an access link, that is, radio communication with the gNB 200 and radio communication with the IAB node 300. The radio communicator 110 may also perform radio communication in a side link, that is, radio communication with other UEs 100. The radio communicator 110 includes a receiver 111 and a transmitter 112. The receiver 111 performs various types of reception under the control of the controller 120. The receiver 111 includes an antenna, and converts (down-converts) a radio signal received by the antenna into a baseband signal (reception signal) and outputs the converted signal to the controller 120. The transmitter 112 performs various types of transmission under the control of the controller 120. The transmitter 112 includes an antenna, and converts (up-converts) a baseband signal (transmission signal) output by the controller 120 into a radio signal and transmits the converted signal from the antenna.

The controller 120 performs various types of control in the UE 100. The controller 120 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of layers to be described below. The controller 120 may perform each process in the UE 100 in each embodiment to be described below.

### Configuration of Protocol Stack

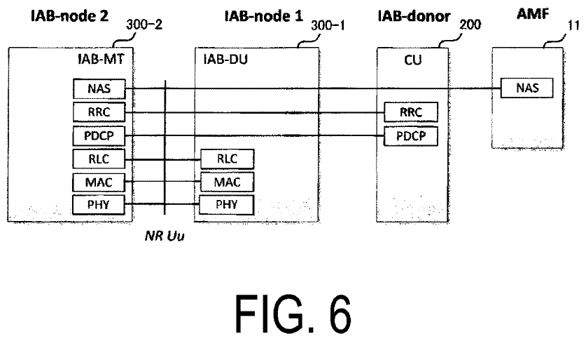

A configuration of a protocol stack according to the embodiment will be described. FIG. 6 is a diagram illustrating an example of a protocol stack related to RRC connection and NAS connection of the IAB-MT.

As illustrated in FIG. 6, the IAB-MT of the IAB node 300-2 includes a physical (PHY) layer, a Medium Access Control (MAC) layer, a Radio Link Control (RLC) layer, a Packet Data Convergence Protocol (PDCP) layer, a Radio Resource Control (RRC) layer, and a Non-Access Stratum (NAS) layer.

The PHY layer performs coding and decoding, modulation and demodulation, antenna mapping and demapping, and resource mapping and demapping. Data and control information are transmitted between the PHY layer of the IAB-MT of the IAB node 300-2 and the PHY layer of the IAB-DU of the IAB node 300-1 via a physical channel.

The MAC layer performs priority control of data, retransmission processing through hybrid ARQ (Hybrid Automatic Repeat reQuest (HARQ)), a random access procedure, and the like. Data and control information are transmitted between the MAC layer of the IAB-MT of the IAB node 300-2 and the MAC layer of the IAB-DU of the IAB node 300-1 via a transport channel. The MAC layer of the IAB-DU includes a scheduler. The scheduler determines a transport format (transport block size, Modulation and Coding Scheme (MCS)) and assigned resource blocks for an uplink and a downlink.

The RLC layer transmits data to the RLC layer on the reception side by using functions of the MAC layer and the PHY layer. Data and control information are transmitted between the RLC layer of the IAB-MT of the IAB node 300-2 and the RLC layer of the IAB-DU of the IAB node 300-1 via a logical channel.

The PDCP layer performs header compression/decompression and encryption/decryption. Data and control information are transmitted between the PDCP layer of the IAB-MT of the IAB node 300-2 and the PDCP layer of the donor node 200 via a radio bearer.

The RRC layer controls the logical channel, the transport channel, and the physical channel according to establishment, re-establishment, and release of the radio bearer. RRC signaling for various configurations is transmitted between the RRC layer of the IAB-MT of the IAB node 300-2 and the RRC layer of the donor node 200. When an RRC connection with the donor node 200 is present, the IAB-MT is in an RRC connected state. When no RRC connection with the donor node 200 is present, the IAB-MT is in an RRC idle state.

An NAS layer that is positioned upper than the RRC layer performs session management, mobility management, and the like. NAS signaling is transmitted between the NAS layer of the IAB-MT of the IAB node 300-2 and the AMF 11.

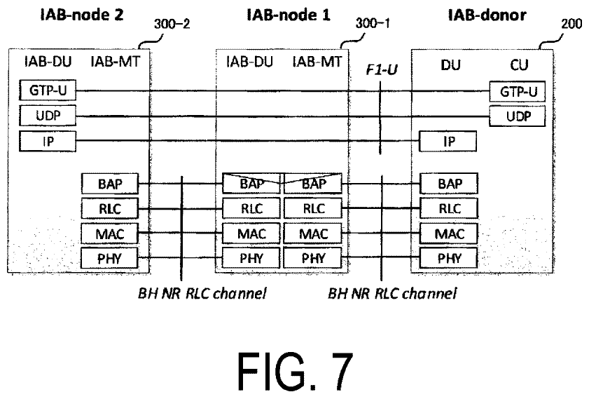

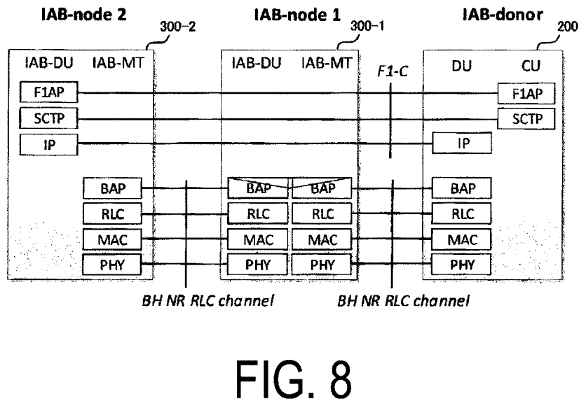

FIG. 7 is a diagram illustrating a protocol stack related to the F1-U protocol. FIG. 8 is a diagram illustrating a protocol stack related to the F1-C protocol. Here, an example in which the donor node 200 is divided into the CU and the DU is illustrated.

As illustrated in FIG. 7, the IAB-MT of the IAB node 300-2, the IAB-DU of the IAB node 300-1, the IAB-MT of the IAB node 300-1, and the DU of the donor node 200 each includes a Backhaul Adaptation Protocol (BAP) layer as an upper layer of the RLC layer. The BAP layer is a layer for performing a routing process and a bearer mapping/demapping process. In the backhaul, the IP layer is transmitted via the BAP layer, which allows routing by a plurality of hops.

In each backhaul link, a Protocol Data Unit (PDU) of the BAP layer is transmitted by a backhaul RLC channel (BH NR RLC channel). A plurality of backhaul RLC channels is configured in each BH link, thereby enabling traffic prioritization and Quality of Service (QoS) control. The PDU of the BAP is associated with the backhaul RLC channel by the BAP layer of each IAB node 300 and the BAP layer of the donor node 200.

As illustrated in FIG. 8, the protocol stack of the F1-C protocol includes an F1AP layer and an SCTP layer instead of a GTP-U layer and a UDP layer illustrated in FIG. 7.

In the following, processes or operations performed in the IAB-DU and IAB-MT of the IAB may be simply described as processes or operations of the “IAB”. For example, the transmission of a message of the BAP layer to the IAB-MT of the IAB node 300-2 by the IAB-DU of the IAB node 300-1 will be described as the transmission of the message to the IAB node 300-2 by the IAB node 300-1. Processes or operations of the DU or CU of the donor node 200 may also be described simply as processes or operations of the “donor node”.

An upstream direction and an uplink (UL) direction may be used without distinction. A downstream direction and a downlink (DL) direction may be used without distinction.

Mobile IAB Node At present, 3GPP has started to study the introduction of a mobile IAB node. The mobile IAB node is, for example, a mobile IAB node. The mobile IAB node may be a movable IAB node. Alternatively, the mobile IAB node may be an IAB node with the ability to move. Alternatively, the mobile IAB node may be an IAB node that is currently stationary but is certain to move in the future (or is expected to move in the future).

The mobile IAB node allows, for example, the UE 100 under the control of the mobile IAB node to receive services from the mobile IAB node while moving in accordance with the movement of the mobile IAB node. For example, a case is assumed in which a user (or UE 100) who is getting on a vehicle receives services via a mobile IAB node installed in the vehicle.

On the other hand, in contrast to the mobile IAB node, an IAB node that does not move also exists. Such an IAB node may be referred to as an intermediate IAB node. The intermediate IAB node is, for example, an IAB node that does not move. Alternatively, the intermediate IAB node may be an IAB node that is stationary. The intermediate IAB node may be a stationary IAB node. Alternatively, the intermediate IAB node may be an IAB node that is stationary (or does not move) in a state of being installed at its installation location. Alternatively, the intermediate IAB node may be a stationary IAB node that does not move. The intermediate IAB node may be a fixed IAB node.

The mobile IAB node can also be connected to the intermediate IAB node. The mobile IAB node can also be connected to the donor node 200. The mobile IAB node can also change its connection destination due to its movement (migration or handover). A connection source may be the intermediate IAB node. The connection source may be the donor node 200. The connection destination may be the intermediate IAB node. The connection destination may be the donor node 200.

In the following, the migration of the mobile IAB node and the handover of the mobile IAB node may be used without distinction.

In the following, a mobile IAB node may be a “mobile IAB node”. The mobile IAB node may be a “migrating IAB node”. In either case, the node may be referred to as a mobile IAB node.

### Cell Reselection Procedure According to First Embodiment

The cell reselection procedure according to the first embodiment will be described.

The UE 100 in the RRC idle state or the RRC inactive state performs the cell reselection procedure to migrate from a current serving cell to a neighboring cell as the UE 100 migrates. More specifically, the UE 100 specifies a neighboring cell on which the UE 100 itself needs to camp by the cell reselection procedure and reselects the specified neighboring cell. Frequencies (carrier frequencies) that are the same between the current serving cell and the neighboring cell will be referred to as intra-frequencies, and frequencies (carrier frequencies) that are different between the current serving cell and the neighboring cell will be referred to as inter-frequencies. The current serving cell and the neighboring cell may be managed by the same gNB 200 or may be managed by the gNBs 200 different from each other.

The cell reselection procedure includes an intra-frequency cell reselection procedure and an inter-frequency cell reselection procedure.

In the intra-frequency cell reselection procedure, cell reselection is performed based on ranking of cells. In the intra-frequency cell reselection procedure, for example, following processing is performed.

First, the UE 100 performs measurement processing of measuring radio quality of each of the serving cell and the neighboring cell. More specifically, the UE 100 measures RSRP and RSRQ of a Cell Defining-Synchronization Signal and PBCH block (CD-SSB) of each of the serving cell and the neighboring cell.

Second, the UE 100 calculates a ranking criterion (Rs) for the serving cell and a ranking criterion (Rn) for the neighboring cell for all cells satisfying a cell selection criterion S. Rs and Rn are calculated by using the following equations, respectively.

$$Rs = {Q}_{meas , s} + {Q}_{hyst} - {Qoffset}_{temp} \qquad ( 1 )$$

$$Rn = {Q}_{meas , n} - Qoffset - {Qoffset}_{temp} \qquad ( 2 )$$

In Equation (1), Q_{meas, s} represents Reference Signal Received Power (RSRP) (measurement value) for the serving cell. In Equation (2), Q_{meas, n} represents RSRP (measurement value) for the neighboring cell. Qoffsetₜₑₘₚ is an offset value to be temporarily used. Qoffset is an offset value for adjusting (RSRP) used in the ranking criterion (Rn) for the neighboring cell.

The UE 100 basically reselects a cell of a highest rank from the two ranking criteria Rs and Rn.

Note that the cell selection criterion S is a criterion for selecting a cell whose RSRP exceeds an RSRP minimum required level and whose RSRQ exceeds an RSRQ minimum required level.

On the other hand, according to the inter-frequency cell reselection procedure, cell reselection is performed based on an absolute frequency priority. The frequency priority is provided from the gNB 200 to the UE 100 by broadcast signaling (e.g., system information block) or dedicated signaling (e.g., RRC release (RRCRelease) message). In the inter-frequency cell reselection procedure, for example, the following processing is performed.

First, the UE 100 performs measurement processing of measuring radio quality of each of the serving cell and the neighboring cell. More specifically, the UE 100 measures always the radio quality for a frequency having a priority higher than the priority of the frequency of the current serving cell. For a frequency having a priority equal to or a priority lower than the priority of the frequency of the current serving cell, when the radio quality of the current serving cell is lower than predetermined quality, the UE 100 measures the radio quality for a frequency having the equal priority or the lower priority.

Second, based on the measurement result, the UE 100 performs cell reselection processing of reselecting a cell on which the UE 100 itself camps. More specifically, the UE 100 may perform the cell reselection to the neighboring cell when the priority of the frequency of the neighboring cell is higher than the priority of the current serving cell and when the neighboring cell satisfies a predetermined quality criterion (i.e., minimum quality criterion) for a predetermined period of time. When the priorities of the frequencies of the neighboring cells are the same as the priority of the current serving cell, the UE 100 may rank the radio quality of the neighboring cells and perform cell reselection for the neighboring cells ranked higher than the ranking of the current serving cell for a predetermined period of time. When a frequency priority of a neighboring cell is lower than the priority of the current serving cell, the radio quality of the current serving cell is lower than a radio quality threshold, and the radio quality of the neighboring cell is continuously higher than another radio quality threshold over a predetermined period of time, the UE 100 may perform cell reselection to the neighboring cell.

The above-described example has been described as an example where the UE 100 performs the cell reselection procedure. However, the IAB-MT of the IAB node 300 can also execute the cell reselection procedure.

### Communication Control Method According to First Embodiment

A communication control method according to the first embodiment will be described.

The mobile IAB node can broadcast mobile-IAB cell type information (or mobile-relay node cell type indication) indicating that the mobile IAB node itself is a mobile IAB node. The mobile-IAB cell type information is, for example, one-bit information. The UE 100 having received mobile-IAB cell type indication can recognize that the cell having transmitted the information is a mobile IAB node cell. Upon recognizing that the cell is a mobile IAB cell, the UE 100 can perform appropriate processing such as executing a cell selection/reselection procedure on the cell.

An object of the first embodiment is to enable the UE 100 having received mobile-IAB cell type information to appropriately perform processing.

In the first embodiment, an example will be described in which the UE 100 performs a predetermined operation in an inter-frequency cell reselection procedure when having received mobile-IAB cell type information from a cell.

Specifically, first, a user equipment (for example, the UE 100) receives mobile-IAB cell type information indicating being a mobile IAB cell from the mobile IAB cell. Second, the user equipment performs either one of executing an inter-frequency cell reselection procedure by considering a frequency priority of a frequency used in the mobile IAB cell as the highest priority, or executing the inter-frequency cell reselection procedure by considering the frequency priority of the frequency used in the mobile IAB cell as the lowest priority.

As described above, when the mobile-IAB cell type indication is received, the UE 100 performs the inter-frequency cell reselection procedure by setting the frequency priority of the frequency used in the cell, which has broadcast the mobile-IAB cell type information, to the highest priority, or performs the inter-frequency cell reselection procedure by setting the frequency priority to the lowest priority. As a result, the UE 100 can reselect the mobile IAB cell or not reselect the mobile IAB cell, and can appropriately execute processing (inter-frequency cell reselection procedure in the first embodiment) upon receiving the mobile-IAB cell type information.

Example of Operation according to First Embodiment An example of an operation according to the first embodiment will be described.

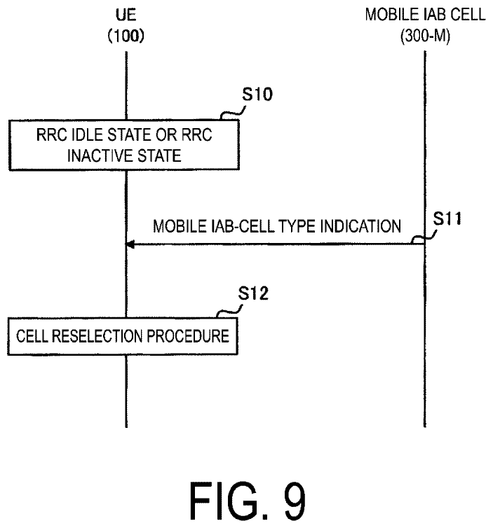

FIG. 9 is a diagram illustrating an operation example according to the first embodiment. Hereinafter, a cell of a mobile IAB node 300-M may be referred to as a “mobile IAB cell”.

As illustrated in FIG. 9, in step S10, the UE 100 transitions to the RRC idle state or the RRC inactive state.

In step S11, the mobile IAB cell 300-M broadcasts mobile-IAB cell type information indicating that the mobile IAB cell 300-M itself is a mobile-IAB cell. The mobile IAB cell 300-M may broadcast the mobile-IAB cell type information by using an SIB.

Note that the order of step S10 and step S11 may be reversed.

In step S12, the UE 100 receives the mobile-IAB cell type information. The UE 100 then performs either one of executing an inter-frequency cell reselection procedure by considering a frequency priority of a frequency used in the mobile IAB cell as the highest priority, or executing the inter-frequency cell reselection procedure by considering the frequency priority of the frequency used in the mobile IAB cell as the lowest priority.

First, the operation of the UE 100 to consider the frequency as the highest frequency priority may be applied when the UE 100 is moving at high speed. For example, the UE 100 acquires moving speed of itself from speed information, position information (the position information may be measurement information obtained by GPS or an accelerometer, for example. The position information may be information calculated from the number of cells through which the UE 100 has passed in a certain period of time), or the like, and compares the moving speed with a speed threshold. When the moving speed of the UE 100 is higher than the speed threshold (i.e., when the UE 100 moves at high speed), the frequency priority of the frequency used in the mobile JAB cell may be considered as the highest frequency priority. The speed threshold may be configured (or broadcast) in advance from the gNB 200. Alternatively, the UE 100 may perform the inter-frequency cell reselection procedure by applying a special frequency priority to the frequency instead of considering the frequency as the highest frequency priority. The special frequency priority may be broadcast from the gNB 200 and received by the UE 100 in advance. The special frequency priority is a frequency priority used in the inter-frequency cell reselection procedure, and may be broadcast from the gNB 200 by an information element (IE) different from a frequency priority included in a SIB4 (hereinafter, may be referred to as a “normal frequency priority”). The special frequency priority may be broadcast using the SIB (for example, SIB4). The UE 100 may consider the frequency as the highest priority when granted by the network. The notification of the grant may be performed in advance from the network to the UE 100 with connection grant information. Details of the connection grant information will be described in a second embodiment. The UE 100 can easily reselect the mobile JAB cell 300-M in the inter-frequency cell reselection procedure by considering the frequency as the highest frequency priority.

Second, the operation in which the UE 100 considers the frequency as the lowest priority may be applied when the UE 100 is moving at low speed (or when being stationary). For example, the UE 100 may acquire its own moving speed from speed information, position information, or the like, compare the acquired moving speed with a speed threshold, and consider the frequency as the lowest priority when its own moving speed is equal to or lower than the speed threshold (i.e., when moving at a low speed or being stationary). Alternatively, the UE 100 may execute the inter-frequency cell reselection procedure using a normal frequency priority to the frequency instead of considering the frequency as the lowest frequency priority. The UE 100 may consider the frequency used in the mobile JAB cell 300-M as the lowest frequency priority when not granted by the network. The notification of being not granted may be performed in advance from the network to the UE 100 with the connection grant information. By considering the frequency as the lowest frequency priority, the UE 100 can easily reselect a cell other than the mobile JAB cell. Further, by causing the frequency to have the normal frequency priority, the UE 100 can execute the inter-frequency cell reselection procedure by treating the mobile JAB cell the same as other cells.

### Other Example According to First Embodiment

It has been described in the first embodiment that the UE 100 executes the inter-frequency cell reselection procedure by considering the frequency used in the mobile JAB cell as the highest priority, or executes the inter-frequency cell reselection procedure by considering the frequency as the lowest priority while not limited thereto. For example, the UE 100 may consider the mobile IAB cell as the highest priority or may consider the mobile IAB cell as the lowest priority. That is, the UE 100 may consider the mobile IAB cell itself as the highest priority and execute the inter-frequency cell reselection procedure, or may consider the mobile IAB cell itself as the lowest priority and execute the inter-frequency cell reselection procedure.

### Second Embodiment

A second embodiment will be described. In the second embodiment, differences from the first embodiment will mainly be described.

In the second embodiment, an example will be described in which the UE 100 camps on a mobile IAB cell 300-M or establishes an RRC connection to a mobile IAB cell 300-M when granted by a network.

Specifically, first, a user equipment (for example, the UE 100) receives connection grant information indicating presence or absence of connection grant to a mobile IAB cell from a network. Second, the user equipment receives mobile-IAB cell type information indicating being a mobile IAB cell from the mobile IAB cell. Third, the user equipment performs either one of executing predetermined processing on the mobile IAB cell based on the connection grant information, or not executing the predetermined processing on the mobile IAB cell. Here, the predetermined processing is at least any of considering that the mobile IAB cell is not barred, camping on the mobile IAB cell, and establishing an RRC connection to the mobile IAB cell.

As described above, when the UE 100 receives mobile-IAB cell type information and connection to the mobile IAB cell is granted, the UE 100 can consider the mobile IAB cell as not being barred, camp on the mobile IAB cell, or establish the RRC connection to the mobile IAB cell. On the other hand, even when mobile-IAB cell type information is received, without connection grant to the mobile IAB cell, the UE 100 can neither consider the mobile IAB cell as being barred, camp on the mobile IAB cell, nor establish an RRC connection to the mobile IAB cell.

Accordingly, for example, it is also possible to allow a specific user who has made a contract to connect to the mobile IAB cell 300-M and not to allow other users to connect to the mobile IAB cell 300-M, and such control can be performed on the network side. As a result, for example, the UE 100 that has received the mobile-IAB cell type information can appropriately perform processing.

### Operation Example According to Second Embodiment

An operation example according to the second embodiment will be described.

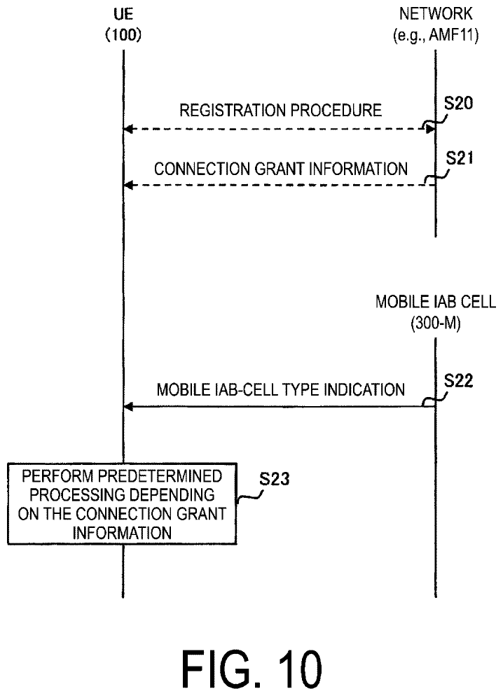

FIG. 10 is a diagram illustrating an operation example according to the second embodiment.

As illustrated in FIG. 10, the UE 100 may execute a registration procedure with a network to perform initial registration to the network (e.g., AMF 11). The network may transmit to the UE 100 the connection grant information being included in authentication information, configuration information, or the like used in the registration procedure. The connection grant information is, for example, information indicating presence or absence of connection grant to the mobile IAB cell 300-M. The UE 100 may also transmit to the network a connection grant request to the mobile IAB cell 300-M. The network may determine whether the UE 100 can connect to the mobile IAB cell 300-M or not based on subscriber information (e.g., service contract information, for example). The network may transmit to the UE 100 the connection grant information in accordance with the determination on whether the connection is granted or not. The UE 100 which has received the connection grant information can recognize whether connection to the mobile IAB cell 300-M is granted or not. For example, the AMF 11 may transmit the connection grant information to the UE 100 by using a Security Mode Command message, a Registration Accept message, or the like, which are NAS messages. Alternatively, in the UE 100, the connection grant information may be written in advance in a storage medium such as a Subscriber Identity Module (SIM). When the connection grant information is received from the AMF 11, when written in the UE 100 in advance, or in the both cases, an upper layer (for example, the NAS layer) of the UE 100 may manage the connection grant information. In the case above, the upper layer may output the connection grant information to an AS layer.

In step S22, the mobile IAB cell 300-M broadcasts mobile-IAB cell type information. The mobile IAB cell 300-M may broadcast the mobile-IAB cell type information by using an SIB. Note that a normal cell that is not the mobile IAB cell 300-M does not broadcast the mobile-IAB cell type information. The normal cell may refer to a cell that does not move, such as the gNB 200, a fixed IAB node cell that does not move, a macro cell, a large cell, a small cell, or an indoor cell.

In step S23, based on the connection grant information, the mobile IAB cell 300-M performs either one of executing predetermined processing on the mobile IAB cell 300-M, or not executing predetermined processing on the mobile IAB cell 300-M. Here, the predetermined processing is at least any of, for example, considering that the mobile IAB cell is not barred, camping on the mobile IAB cell 300-M, and establishing the RRC connection to the mobile IAB cell 300-M. Details of the control are as follows.

First, when connection to the mobile IAB cell is allowed in the connection grant information, the UE 100 determines that the UE 100 is allowed to camp on and/or establish the RRC connection to the mobile IAB cell 300-M. That is, the UE 100 may consider the mobile IAB cell 300-M as a cell that is not barred. Alternatively, the UE 100 may execute the cell reselection procedure with the mobile IAB cell 300-M as a candidate for cell reselection. Specifically, as described in the first embodiment, the UE 100 may execute the inter-frequency cell reselection procedure by considering a frequency priority of a frequency used in the mobile IAB cell 300-M as the highest frequency priority. Alternatively, the UE 100 may apply special frequency priority to the frequency used in the mobile IAB cell 300-M, as described in the first embodiment. The UE 100 may execute the intra-frequency cell reselection procedure by setting the ranking criterion (Rn or Rs) of the mobile IAB cell 300-M to the highest rank. Alternatively, the UE 100 may establish the RRC connection to the mobile IAB cell 300-M. Specifically, the UE 100 may establish the RRC connection by sending RRC messages, such as an RRC Connection Setup Request (RRCSetupRequest) message or an RRC Resume Request (RRCResumeRequest) message, to the mobile IAB cell 300-M.

Second, when connection to the mobile IAB cell is not allowed in the connection grant information, the UE 100 determines that UE 100 is not allowed to camp on and/or not allowed to establish the RRC connection to the mobile IAB cell 300-M. That is, the UE 100 may consider the mobile IAB cell 300-M as a barred cell. Alternatively, the UE 100 may execute the cell reselection procedure without using the mobile IAB cell 300-M as a candidate for the cell reselection. That is, the UE 100 does not perform cell reselection of the mobile IAB cell 300-M. Alternatively, as described in the first embodiment, the frequency of the mobile IAB cell 300-M may be considered as the lowest priority, or a normal frequency priority may be applied to the frequency of the mobile IAB cell 300-M. The UE 100 may execute the intra-frequency cell reselection procedure by setting the ranking criterion (Rn or Rs) of the mobile IAB cell 300-M to the lowest rank. Alternatively, the UE 100 does not establish the RRC connection to the mobile IAB cell 300-M. Specifically, the UE 100 may not transmit RRC messages related to RRC connection setup, such as the RRC Connection Setup Request message and the RRC Resume Request message, to the mobile IAB cell 300-M.

### OTHER EMBODIMENTS

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

The term “network node” mainly means a base station, but may also mean a core network apparatus or a part (CU, DU, or RU) of the base station. The network node may include a combination of at least a part of the apparatus of the core network and at least a part of the base station.

A program causing a computer to execute each processing operation performed by the UE 100, the gNB 200, or the IAB node 300 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing each processing operations performed by the UE 100, the gNB 200, or the IAB node 300 may be integrated, and at least part of the UE 100 or the gNB 200 may be configured as a semiconductor integrated circuit (a chipset or a System on a Chip (SoC)).

The functions achieved by the UE 100, the gNB 200 (network node), or the IAB node 300 may be implemented in circuitry or processing circuitry including general-purpose processors, special-purpose processors, integrated circuits, Application Specific Integrated Circuits (ASICs), a Central Processing Unit (CPU), conventional circuits, and/or combinations thereof, all of which are programmed to achieve the described functions. The processor includes transistors and other circuits and is considered as circuitry or processing circuitry. The processor may be a programmed processor that executes a program stored in memory. In the present description, circuitry, a unit, a means each are hardware programmed to achieve, or hardware to execute the recited functions. The hardware may be any hardware disclosed in the present description, or any hardware programmed to achieve or known to execute the described functions. When the hardware is a processor that is considered to be a type of circuitry, the circuitry, the means, or the unit each are a combination of hardware and software used for configuring the hardware and/or processor.

The phrases “based on” and “depending on/in response to” used in the present disclosure do not mean “based only on” and “only depending on/in response to” unless specifically stated otherwise. The phrase “based on” means both “based only on” and “based at least in part on.” The phrase “depending on” means both “only depending on” and “at least partially depending on.” The terms “include,” “comprise” and variations thereof do not mean “include only items stated” but instead mean “may include only items stated” or “may include not only the items stated but also other items.” The term “or” used in the present disclosure is not intended to be “exclusive or.” Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

The embodiments have been described above in detail with reference to the drawings, but specific configurations are not limited to those described above, and various design variations can be made without departing from the gist of the present disclosure. The embodiments, the operation examples, or the different types of processing may be combined as appropriate as long as they are not inconsistent with each other.

### Supplements

### Supplementary Note 1

A communication control method used in a cellular communication system, the communication control method including the steps of:
receiving, by a user equipment, mobile-IAB cell type information indicating being a mobile IAB cell from the mobile IAB cell; and
performing, by the user equipment, either one of executing an inter-frequency cell reselection procedure by considering a frequency priority of a frequency used in the mobile IAB cell as the highest priority, or executing the inter-frequency cell reselection procedure by considering the frequency priority of the frequency used in the mobile IAB cell as the lowest priority.

### Supplementary Note 2

The communication control method of Supplementary Note 1,
in which the step of performing either one includes a step of executing, by the user equipment, the inter-frequency cell reselection procedure by considering the frequency priority as the highest priority when the user equipment is moving at a speed higher than a speed threshold.

### Supplementary Note 3

The communication control method of Supplementary Note 1 or 2,
in which the step of performing either one includes a step of executing, by the user equipment, the inter-frequency cell reselection procedure by applying a special frequency priority to the frequency priority when the user equipment is moving at a speed higher than a speed threshold.

### Supplementary Note 4

The communication control method of any one of Supplementary Notes 1 to 3,
in which the step of performing either one includes a step of executing, by the user equipment, the inter-frequency cell reselection procedure by considering the frequency priority as the lowest priority when the user equipment is moving at a speed lower than or equal to a speed threshold.

### Supplementary Note 5

The communication control method of any one of Supplementary Notes 1 to 4,
in which the step of performing either one includes a step of executing, by the user equipment, the inter-frequency cell reselection procedure by using a frequency priority broadcast with an SIB4 when the user equipment is moving at a speed lower than or equal to a speed threshold.

### Supplementary Note 6

A communication control method used in a cellular communication system, the communication control method including the steps of:
receiving, by a user equipment, connection grant information indicating presence or absence of connection grant to a mobile IAB cell from a network;
receiving, by the user equipment, mobile-IAB cell type information indicating being the mobile IAB cell from the mobile IAB cell; and
performing, by the user equipment, based on the connection grant information, either one of executing predetermined processing on the mobile IAB cell, or not executing the predetermined processing on the mobile IAB cell,
in which the predetermined processing is at least one of considering that the mobile IAB cell is not barred, camping on the mobile IAB cell, and establishing an RRC connection to the mobile IAB cell.

### Supplementary Note 7

The communication control method of any one of Supplementary notes 1 to 6,
in which the step of performing the predetermined processing includes a step of executing, by the user equipment, the predetermined processing when the connection grant information indicates that the connection to the mobile IAB cell is granted, and not executing the predetermined processing when the connection grant information indicates that the connection to the mobile IAB cell is not granted.

### REFERENCE SIGNS

1: Cellular communication system
10: 5GC
11: AMF
100: UE
110: Radio communicator
120: Controller
200: Donor node (gNB)
210: Radio communicator
230: Controller
300: IAB node
300-M: Mobile IAB node (mobile IAB cell)
310: Radio communicator
320: Controller

1. A communication control method used in a cellular communication system, the communication control method comprising:
receiving, by a user equipment, mobile-Integrated Access and Backhaul (IAB) cell type information indicating being a mobile IAB cell from the mobile IAB cell; and
executing, by the user equipment, an inter-frequency cell reselection procedure by considering a frequency priority of a frequency used in the mobile IAB cell as a highest priority, wherein
the mobile IAB cell is a cell that connection to another IAB node is barred by using connection grant information indicating that connection to the mobile IAB cell is allowed.

2. An user equipment in a cellular communication system, the user equipment comprising transceiver circuitry and processing circuitry operatively associated with the transceiver circuitry and configured to execute processing of:
receiving mobile-Integrated Access and Backhaul (IAB) cell type information indicating being a mobile IAB cell from the mobile IAB cell; and
executing an inter-frequency cell reselection procedure by considering a frequency priority of a frequency used in the mobile IAB cell as a highest priority, wherein the mobile IAB cell is a cell that connection to another IAB node is barred by using connection grant information indicating that connection to the mobile IAB cell is allowed.

3. A cellar communication system comprising a mobile IAB and the user equipment according claim 1.

4. A non-transitory computer-readable storage medium storing a program for causing a computer of an user equipment in a cellular communication system to execute processing comprising:
receiving mobile-Integrated Access and Backhaul (IAB) cell type information indicating being a mobile IAB cell from the mobile IAB cell; and
executing an inter-frequency cell reselection procedure by considering a frequency priority of a frequency used in the mobile IAB cell as a highest priority, wherein
the mobile IAB cell is a cell that connection to another IAB node is barred by using connection grant information indicating that connection to the mobile IAB cell is allowed.

5. A chipset for an user equipment in a cellular communication system, the chipset comprising:
receiving mobile-Integrated Access and Backhaul (IAB) cell type information indicating being a mobile IAB cell from the mobile IAB cell; and
executing an inter-frequency cell reselection procedure by considering a frequency priority of a frequency used in the mobile IAB cell as a highest priority, wherein
the mobile IAB cell is a cell that connection to another IAB node is barred by using connection grant information indicating that connection to the mobile IAB cell is allowed.
